(19) United States
(12) Patent Application Publication
(10) Pub. No.: US 2011/0145048 A1
(43) Pub. Date: Jun. 16, 2011

(54) System & Method for Presenting Content To Captive Audiences

(76) Inventor: DAVID K.Y. LIU, FREMONT, CA (US)

(21) Appl. No.: 12/965,547

(22) Filed: Dec. 10, 2010

Related U.S. Application Data
(60) Provisional application No. 61/285,491, filed on Dec. 10, 2009.

(51) Int. Cl. G06Q 30/00

(52) U.S. Cl. 705/14.19; 705/14.1; 705/14.38

(57) ABSTRACT

Marketing/advertising presentations are customized for transit passengers, such as commercial airline passengers. The passengers offer a good captive audience during long-duration trips since there is little opportunity for distraction. The passengers' attention and participation can be guaranteed by offering differing levels of incentives (e.g. reduced fare, upgraded seats, product/service discounts, etc.).

### RELATED APPLICATION DATA

The present application claims the benefit under 35 U.S.C. 119(e) of the priority date of Provisional Application Ser. No. 61/285,491 filed Dec. 10, 2009 which is hereby incorporated by reference.

### FIELD OF THE INVENTION

The invention relates to methods for presenting advertising content to captive audiences in different venues.

### BACKGROUND

Methods for advertising to a captive audience are well known in the art. Examples of such methods of advertisement include video screens at gas pumps, billboards in train and subway stations, digital signage on buses, kiosks in malls and myriad other implements in high-traffic spaces. Such methods are widespread and extremely effective for presenting short-term advertisements to their audiences, but one of the major problems for advertisers today is how to gain a captive audience for a longer-term sales pitch.

Somewhat unrelated to this issue is the desire by transportation enterprises to satisfy their customers, including during long trips. At the same time slim profit margins in such enterprises have led to an ever growing reduction of customer amenities during transit, as evidenced by the elimination of food and entertainment services on many long distance flights. The airlines in particular are under intense stress to increase seat utilization while simultaneously cutting costs per passenger.

Accordingly there is clearly a long-felt need for a solution capable of addressing these deficiencies in the prior art.

### SUMMARY OF THE INVENTION

An object of the present invention, therefore, is to overcome the aforementioned limitations of the prior art.

### DESCRIPTION OF THE DRAWINGS

FIG. 1 is a flow chart illustrating the steps performed by an exemplary embodiment of the present invention.

### DETAILED DESCRIPTION

As noted above, one of the major problems for advertisers is to gain a captive audience to whom a long-duration sales pitch can be made. Advertisers for timeshares or infomercials typically expend significant sums to solicit a captive audience without the assurance of getting attendees. There is a great benefit to be able to obtain a captive audience for long-duration sales presentations at low cost to the advertisers.

Transit passengers, particularly commercial airline passengers, make for a good captive audience during long-duration flights. There is little distraction to capturing their full attention. Therefore on long-duration flights it would be ideal to make a sales pitch to these captive audiences, depending on the particular cross-section of passengers present. Since airlines also operate under extremely tight profit margins, it would be advantageous for them to cooperate with third parties willing to subsidize some portion of a passenger's fare.

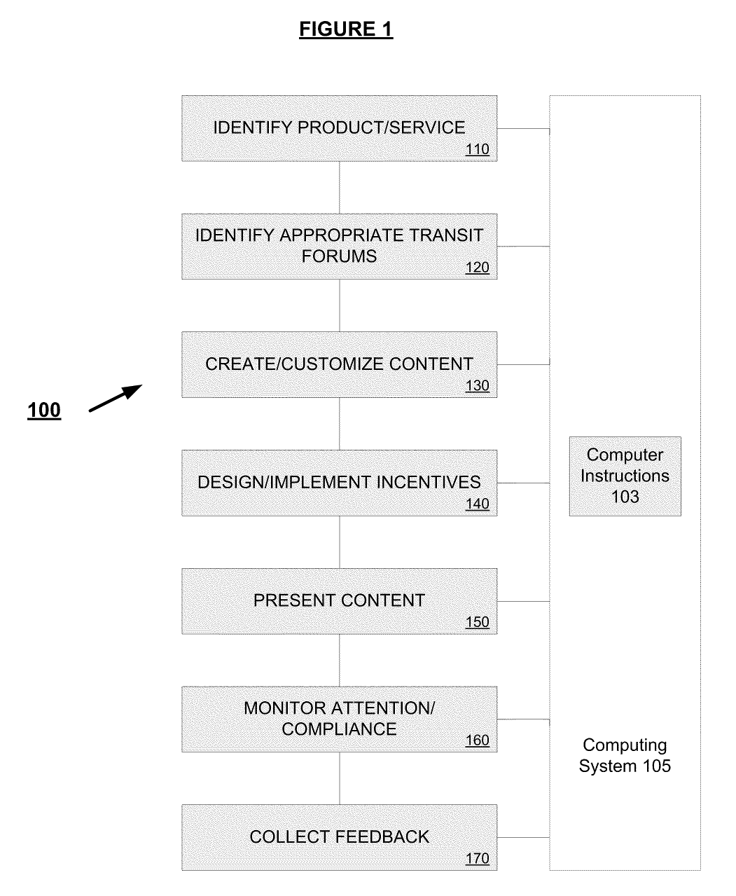

FIG. 1 illustrates a preferred process of the invention, which an advertiser can undertake in order to take advantage of the undivided attention of such passengers and deliver a commercial pitch. The preferred process is implemented in whole or at least in part as described below by a computer program of computer instructions 103 embodied as a product recorded in tangible media form, and which can executed on a computing system 105. The computing system 105 can include any conventional form and number of computing devices suitable for carrying out electronic computations and effectuate the goals of the present disclosure, as well as other communications peripherals and storage devices to support its operations. It is further understood that these computing devices can have access where necessary to communications networks, including the Internet and/or other local networks. Some of the computing devices may be in the form of computing servers operating on an Internet side, while others may be associated with a transportation vehicle.

The first step for advertisers, depicted at step 110 is to identify the product/service to be pitched and the associated content. Again this operation can be done manually and/or automatically using the assistance of computing device 105.

The next step 120 is to locate/identify appropriate for a in which to present said ad content. Some good examples of for a in which an advertiser might find a captive audience include but are not limited to commercial airline flights, passenger trains—including rapid transit lines, cruise ships, movie theaters, concerts and sporting events. Such venues would regularly provide advertisers with an ample and focused audience. It is expected that through observation and reporting feedback the targeting of the ad content to particular for a will be optimized by computing system 105.

Once a forum is identified, the advertiser can focus on customizing the sales pitch, step 130, to fit the needs and interests of their given audience and the particular forum. Through simple market research and focus groups it is rather simple to tailor a long-term sales pitch to the demographic group being targeted. As examples, for flights to vacation destinations, obvious advertisers would be timeshares and vacation homes; for flights on business routes, the obvious advertisers would be productivity enhancement tools. The aforementioned scenarios are only examples and do not comprise an exhaustive list. As noted above it is apparent that much of the content can be located, compiled and presented by computing system 110.

The advertisers define exactly what it is they wish to sell, and they may cooperate with other third parties to package the content into an attractive format. Typically such content can be put into an audiovisual presentation that is designed to be attractive to viewers using computing system 105. Celebrities and/or other popular figures can be used to endorse the product/service being pitched. As part of the content the advertisers can also design any number of conventional feedback tools running on system 105 which allow for participants to provide their responses, interest and other feedback concerning the presentations. The variety of presentations is nearly infinite and can be tailored to each application.

In one embodiment, the participants are offered a variety of different presentations on different products/services, which allows for greater options and possibilities for engagement. The advertiser presentation content and associated perks and fare inducements can be presented to participants at the points of purchase (such as a website for example) in the form of different packages to maximize participation rates. The marketing packages can be designed with content and perks that are related in the sense that the participant can be offered greater incentives for longer presentations, or for presentations which are associated with higher end products/services.

In other instances where the presentation content/perks package is not accepted at the time of ticketing, the transporting entity can share information about passengers so that the content can be targeted nonetheless to the participants in advance. To preserve privacy the passenger information may be limited to basic demographic data, such as age, sex, residence zip code, etc. The advertiser can then offer the inducements, fare reductions, etc. to the passengers before the trip to improve the likelihood of participation. In still other embodiments the presentation/perk packages may offered also at the travel embarkation site. It will be understood that any or all of these options may be employed by an advertiser to increase participation.

A set of incentives are then designed and implemented at step 140. For example, with the cooperation of the transporting entity, a section of the cabin can be set aside as the “sale presentation” section. This cabin section may include additional amenities beyond those offered to other passengers, such as but not limited to, improved seating, discounted or free food/drinks, monetary coupons, discounted or free access to electronic media, players, Internet surfing, etc. Other examples will be apparent to those skilled in the art.

In some applications passengers can decide if they wish to sign up for this section at the time of ticket purchase. Significant discounts can be offered to passengers who choose to sit in the “presentation” section. To the extent such sections require modification beyond the standard cabin environment, the transporting entity may choose to recuperate any costs directly in part or whole from the advertiser(s). Moreover it is expected that airlines and other companies offering such seating will enjoy greater bookings and percentage of capacity. Advertisers will be able to make long-duration sales presentations during flights, train rides, and possibly at movie theaters or sporting events with the audience paying essentially full attention. For example at sporting events the presentations can be made at intermissions, such as between innings, periods, half-time, etc. In some instances it may be useful to set aside a dedicated section of the venue (stadium) for the presentation during the intermission. This section may include special seating, entertainment or other amenities.

All sides benefits in such arrangement. The advertisers benefit from knowing that their advertising budget is well-spent on a totally captive audience, the carrier benefits from receiving money from advertisers and free entertainment programs for the passengers, and finally the passengers benefit from receiving lower airfare/improved accommodations while being informed of new products.

At step 150 the presentation is given to the audience in the particular forum under control of computing system 105 In the case of an airline passenger application, the presentation may be targeted to an audio visual system within a particular physical sub-section of the plane, such as first class, business class, an economy plus class, or simply a section of regular coach. Alternatively in applications where the underlying AV system of the transit vehicle allow for individualized content delivery, the presentation can be targeted on a passenger or seat basis.

In yet other applications the presentations may be in the form of discrete media that is given to passengers individually before or during travel for play on a portably player device such as a digital video player. The players could also be dispensed to passengers with other entertainment media/content pre-loaded so that the user is given the benefit of this perk as well. The players can then be left onboard, dropped off at an exit from the plane, or picked up by airline personnel at the end of travel.

For environments which contain some form of broadband delivery mechanism the content could be downloaded or streamed to a passenger's personal computing device, smartphone or other similar player through a physical or wireless connection by computing system 105. Again the presentation can take any number of forms and the invention is not limited in this respect.

At step 160 the advertiser preferably implements automated measures within the content to ensure that the audience is paying attention during the presentation. A variety of techniques are known in the art for ensuring audience attention, including those disclosed in 20090265214 to Jobs et al incorporated by reference herein. Other mechanisms could be used as well of course consistent with the present teachings. In some instances a live human could ask questions of the audience. Each audience member, for instance, could be asked to follow along and answer questions on a quiz, or even give answers via an electronic input device to the computing system 105.

Following the presentation, audience members can be asked to provide feedback, interest and other similar input at step 170 to computing system 105. Other solicitations can be provided as well, such as the purchase products or services featured in the presentation.

The invention can be customized for different venues. For example at a baseball game, the audience's attention could be directed to a conventional large scoreboard between innings. During breaks in action the audience can be presented with content, questions etc. The audience members could manually fill out physical ballots/cards requesting feedback, or they could participate through text messaging and/or similar mechanisms already employed to garner viewer's votes on event related issues. Similar techniques could be used at other sporting events.

Further incentives and discounts could be offered depending on the venue and the number of purchases made by those attending said presentation. For example public Internet access is only now becoming possible in airplane environments, so participants could be offered free Wi-Fi, free Internet service, etc., as an inducement. In a movie theatre or concert application the participants could be given the option of early admission to the event in exchange for their viewing/listening to the presentation.

The above descriptions are intended as merely illustrative embodiments of the proposed inventions. It is understood that the protection afforded the present invention also comprehends and extends to embodiments different from those above, but which fall within the scope of the present claims.

What is claimed is:

1. A method of presenting advertising content to a captive audience within a transit vehicle under control of a computing system, the method comprising the steps of:
a. adapting at least a first portion of a cabin within said transit vehicle to permit passengers to perceive said advertising content during transit;
b. presenting an option to said passengers to participate as members of said captive audience within said first portion of cabin;
wherein said option includes inducements, incentives and/or other financial consideration offered to said passengers;
c. presenting said advertising content with the computing system to said passengers who become members of said captive audience during said transit;
d. processing feedback from said members of said captive audience in response to step (c) with the computing system.

2. The method of claim 1, wherein said first portion of said cabin section occupies a dedicated portion of said transit vehicle with a plurality of contiguous seats.

3. The method of claim 1 wherein said option is presented to said passengers at a time of purchase for a ticket for said transit.

4. The method of claim 3 wherein said option is presented by a website to an Internet user within a web browser.

5. The method of claim 1 wherein said option is presented to a selected group of said passengers, which selected group is determined by an automated program executing on a computing system adapted to predict suitable audience members for said advertising content.

6. The method of claim 5 wherein said automated program uses passenger demographic data and a collaborative filtering algorithm.

7. The method of claim 5 wherein said automated program is based on a first computing system which accesses passenger information from a passenger information database controlled by an operator of said transit vehicle.

8. The method of claim 1 wherein said transit vehicle is one of an airplane, a train, a bus or a ship.

9. The method of claim 1 wherein said first portion of said cabin is outfitted with amenities exceeding those of a base coach class fare cabin section.

10. The method of claim 9 wherein said first portion of said cabin includes larger and/or more comfortable seating than said base coach class fare cabin section.

11. The method of claim 1 wherein said members of said captive audience pay a reduced price for fare for said transit.

12. The method of claim 1, wherein said plane ticket is sold at a significantly reduced price.

13. The method of claim 1, further including an attention management program adapted to ensure attention of said members of said captive audience during step (c).

14. The method of claim 13, wherein said attention management program and said advertising content are packaged on a machine playable medium and are adapted to run on a portable presentation device.

15. The method of claim 13 further including a feedback program adapted to process said feedback.

16. The method of claim 1, wherein said plane ticket is sold at a significantly reduced price.

17. The method of claim 1, wherein said advertising content is presented in the form of a video communicated to the members of the captive audience through a video display device associated with such member's seats.

18. The method of claim 1, wherein said advertising content is presented as an interactive video on a portable computing device given to said members of the captive audience for use during transit.

19. The method of claim 18, wherein said advertising content is packaged with separate entertainment content on said portable computing device.

20. The method of claim 1, wherein said feedback is conducted via a written questionnaire.

21. The method of claim 1, wherein said feedback is conducted via an electronic device either during or after the presentation.

22. The method of claim 1, further including a step: consummating a transaction with one or more of the members of the captive audience for a product or service presented in said advertising content.

23. A method of presenting advertising content with a computing system to a captive audience within a physical venue having seating for attendees, the method comprising the steps of:
a. adapting at least a first portion of said venue to permit attendees to perceive said advertising content at a pre-event time prior to a scheduled event at the physical venue;
b. presenting an option to said attendees to participate as members of said captive audience within said first portion of said venue;
wherein said option includes inducements, incentives and/or other financial consideration offered to said attendees;
c. presenting said advertising content with the computing system to said attendees who become members of said captive audience during said pre-event time;
d. processing feedback from said members of said captive audience in response to step (c) with the computing system.

24. The method of claim 23, wherein said inducements include preferred seating at said event.

25. The method of claim 23 wherein said inducements include priority in accessing the venue prior to the event.

26. The method of claim 23 wherein said feedback is submitted using a smartphone.

27. A method of presenting advertising content with a computing system to a captive audience the method comprising the steps of:
a. assembling the captive audience in a structure adapted for an entertainment event during a first time period;
b. presenting an option to said captive audience to permit selective members to perceive advertising content at selected advertising times occurring before said first time period, and/or during intermissions of said entertainment event;
wherein said option includes inducements, incentives and/or other financial consideration offered to said members;
c. presenting said advertising content with the computing system to said members of said captive audience during said selected advertising times;
d. processing feedback from said members concerning said advertising content with the computing system.
